(19) United States
(12) Patent Application Publication
(10) Pub. No.: US 2026/0179252 A1
(43) Pub. Date: Jun. 25, 2026

(54) SYSTEMS, APPARATUSES, METHODS, AND NON-TRANSITORY COMPUTER-READABLE STORAGE DEVICES FOR CORNEAL-REFLECTION-BASED EYE-TRACKING USING MULTIPLE CAMERAS

(71) Applicant: HUAWEI TECHNOLOGIES CO, LTD., Shenzhen (CN)

(72) Inventors: Soumil Chugh, Markham (CA); Juntao Ye, Markham (CA); Moshe Eizenman, Kanata (CA)

(21) Appl. No.: 19/001,235

(22) Filed: Dec. 24, 2024

(51) Int. Cl. G06T 7/73; G06T 7/292; G06T 7/60

(52) U.S. Cl. CPC G06T 7/74; G06T 7/292; G06T 7/60; G06T 2207/30201

(57) ABSTRACT

A method for obtaining one or more calibration parameters used for tracking an eye, the method has the steps of: obtaining multiple images of the eye taken from different angles; detecting a single first corneal-reflection point in each of the images; determining a cornea center of the eye in a three-dimensional (3D) coordinate system based on the first corneal-reflection points in the images; determining a pupil center of the eye in the 3D coordinate system based on at least one of images; determining a first direction in the 3D coordinate system based on the cornea center and the pupil center; determining a second direction in the 3D coordinate system based on the cornea center and a target point in the 3D coordinate system; and determining a Kappa angle in the 3D coordinate system between the first and second directions as one of the one or more calibration parameters.

### FIELD OF THE DISCLOSURE

The present disclosure relates generally to eye-tracking systems, apparatuses, methods, and non-transitory computer-readable storage devices, and in particular to systems, apparatuses, methods, and non-transitory computer-readable storage devices for corneal-reflection-based eye-tracking using multiple cameras.

### BACKGROUND

Camera-based or video-based eye-tracking is one of the most popular ways for gaze estimation, wherein the gaze estimation outputs may be either two-dimensional (2D) or three-dimensional (3D) representations. A 2D representation is a directly estimated 2D gaze point on a plane such as a display screen, while a 3D output is an estimated directional gaze vector. In fact, with a 3D gaze vector, a 2D gaze point may be easily obtained by intersecting the 3D gaze vector with the plane such as the display screen. Usually, systems that obtain 3D gaze vectors are preferred since they can be used for tracking a person's gaze direction even without display screens. Generally, the gaze estimation methods comprise two main processes, including a calibration process and a run-time process. The calibration process involves estimating subject-specific parameters that enhances the performance of the eye tracker. The run-time process is the real time tracking of the gaze direction once the calibration process is done.

While there exist various camera-based or video-based eye-tracking methods in prior art, these methods have various disadvantages such as complex calibration, small field-of-view (FOV), complex hardware and/or software, and/or the like.

Therefore, there is a desire for a noel camera-based or video-based eye-tracking method and system for solving at least some of the disadvantages in prior art.

### SUMMARY

According to one aspect of this disclosure, there is provided a computerized method comprising: performing a first set of actions; performing a second set of actions based on said performing the first set of actions; estimating one or more calibration parameters based on said performing the second set of actions; and performing a third set of actions to track an eye of a user in a three-dimensional (3D) coordinate system based on the one or more calibration parameters; wherein the first set of actions comprise: obtaining a plurality of images of the eye taken from different viewing angles, and detecting a single imaged glint in the 3D coordinate system from each of the plurality of images thereby obtaining a plurality of imaged glints in the 3D coordinate system, each imaged glint corresponding to a position at which a light emitted from a light-emitting position and reflected by a cornea of the eye is captured in the corresponding image of the plurality of images; wherein the second set of actions comprise: determining a cornea center of the eye in the 3D coordinate system based on the imaged glints, determining a pupil center of the eye in the 3D coordinate system based on at least one of the plurality of images, and determining a first direction in the 3D coordinate system based on the cornea center and the pupil center; and wherein said estimating the one or more calibration parameters comprises: determining a second direction in the 3D coordinate system based on the cornea center and a target point in the 3D coordinate system, and determining a Kappa angle in the 3D coordinate system between the first direction and the second direction as one of the one or more calibration parameters.

In some embodiments, said determining the cornea center comprises: for each image of the plurality of images, calculating a center of corneal curvature in the 3D coordinate system, thereby obtaining a plurality of centers of corneal curvature; and finding an optimal value of the first distance and an optimal value of the radius such that the centers of corneal curvature substantially converge to a converged point, the converged point being the cornea center; wherein for each image of the plurality of images, the calculation of the center of corneal curvature in the 3D coordinate system is based on: the light-emitting position, a nodal point in the 3D coordinate system corresponding to capturing of the image, a first distance between a point of reflection on the eye corresponding to the image, and the nodal point corresponding to the capturing of the image, an imaged glint of the plurality of imaged glints corresponding to the image, and a radius of the cornea of the eye.

In some embodiments, said determining the cornea center comprises: finding optimal values of k_{qi} and R such that cᵢ (i=1, 2, . . . , N) substantially converge to an optimum point c̅, wherein cᵢ is determined based on:

$$( \frac{l - {q}_{i}}{‖ l - {q}_{i} ‖} - \frac{{o}_{i} - {q}_{i}}{‖ {o}_{i} - {q}_{i} ‖} ) \cdot ( {q}_{i} - {c}_{i} ) = 0$$

for i=1, 2, . . . , N, and

$${q}_{i} = {o}_{i} + {k}_{q i} \frac{{o}_{i} - {u}_{i}}{‖ {o}_{i} - {u}_{i} ‖}$$

where:
l is the light-emitting position,
oᵢ is an i-th nodal point in the 3D coordinate system corresponding to capturing an i-th image of the plurality of images,
k_{qi} is a first distance between a point of reflection on the eye corresponding to the i-th image, and the i-th nodal point,
uᵢ is an i-th imaged glint of the plurality of imaged glints, and
R is a radius of the cornea of the eye.

In some embodiments, the first set of actions further comprises: instructing the user to look at the target point.

In some embodiments, the light is a visible light or an infrared (IR) light.

In some embodiments, the plurality of images are two images.

In some embodiments, said determining the cornea center comprises: computing:

$${min}_{{k}_{q 1} , {k}_{q 2} , R} ‖ {c}_{1} ( {k}_{q 1} , R ) - {c}_{2} ( {k}_{q 2} , R ) ‖$$

where c₁(k_{q1}, R) indicates that c₁ is a function of k_{q1} and R, c₂(k_{q2}, R) indicate that c₂ is a function of k_{q2} and R, and c₁ and c₂ are determined based on:

$$( \frac{l - {q}_{1}}{‖ l - {q}_{1} ‖} - \frac{{o}_{1} - {q}_{1}}{‖ {o}_{1} - {q}_{1} ‖} ) \cdot ( {q}_{1} - {c}_{1} ) = 0$$

$$( \frac{l - {q}_{2}}{‖ l - {q}_{2} ‖} - \frac{{o}_{2} - {q}_{2}}{‖ {o}_{2} - {q}_{2} ‖} ) \cdot ( {q}_{2} - {c}_{2} ) = 0$$

$$and$$

$${q}_{1} = {o}_{1} + {k}_{q 1} \frac{{o}_{1} - {u}_{1}}{‖ {o}_{1} - {u}_{1} ‖}$$

$${q}_{2} = {o}_{2} + {k}_{q 2} \frac{{o}_{2} - {u}_{2}}{‖ {o}_{2} - {u}_{2} ‖}$$

where:
l is the light-emitting position,
o₁ and o₁ are a first nodal point and a second nodal point in the 3D coordinate system related to capturing a first image and a second image of the two images, respectively,
k_{q1} is a first distance between a point of reflection on the eye corresponding to the first image, and the first nodal point,
k_{q2} is a second distance between a point of reflection on the eye corresponding to the second image, and the second nodal point,
u₁ and u₂ are a first imaged glint and a second imaged glint of the plurality of imaged glints, respectively, and
R is a radius of the cornea of the eye; and

calculating the cornea center c as:

$$c = \frac{{c}_{1} ( {k}_{q 1} , R ) + {c}_{2} ( {k}_{q 2} , R )}{2} .$$

In some embodiments, the method further comprises: repeating said performing the first set of actions, said performing the second set of actions, and said estimating the one or more calibration parameters for a plurality of times thereby obtaining a plurality of versions of the one or more calibration parameters; and estimating the one or more calibration parameters by combining the plurality of versions of the one or more calibration parameters.

In some embodiments, the third set of actions comprise: reperforming the first set of actions; reperforming the second set of actions based on said reperforming the first set of actions; and estimating a gaze direction of the eye in the 3D coordinate system based on the first direction obtained from said reperforming the second set of actions, and the Kappa angle, for tracking the eye.

In some embodiments, the third set of actions comprises: reperforming the first set of actions to re-obtain the plurality of images each having a single imaged glint; for each of the plurality of images obtained from said reperforming the first set of actions, determining a first gaze direction of the eye in the 3D coordinate system, thereby obtaining a plurality of first gaze directions; and combining the plurality of first gaze directions to obtain a second gaze direction of the eye in the 3D coordinate system for tracking the eye of the user.

According to one aspect of this disclosure, there is provided a system for performing the above-described methods and/or any of the methods disclosed herein, wherein the system comprising: a light source at the light-emitting position; a plurality of cameras for image capturing; and one or more circuits functionally connected to the light source and the plurality of cameras for performing the above-described methods and/or any of the methods disclosed herein.

According to one aspect of this disclosure, there is provided a system comprising: one or more non-transitory, computer-readable storage media; and one or more processors functionally connected to the one or more non-transitory, computer-readable storage media; wherein the one or more non-transitory, computer-readable storage media comprising computer-executable instructions; and wherein the instructions, when executed, cause the one or more processors to perform any of the above-described methods and/or any of the methods disclosed herein.

According to one aspect of this disclosure, there is provided an apparatus comprising one or more processors functionally connected to one or more memories storing instructions; the one or more processors are configured to execute the instructions to perform any of the above-described methods and/or any of the methods disclosed herein.

According to one aspect of this disclosure, there is provided one or more memories storing instructions; the instructions, when executed, cause one or more processors to perform any of the above-described methods and/or any of the methods disclosed herein.

In another aspect, embodiments of this disclosure provide an apparatus, wherein the apparatus comprises a function or unit to perform any of the above-described methods and/or any of the methods disclosed herein.

In another aspect, embodiments of this disclosure provide a computer readable storage medium, comprising one or more instructions, wherein when the one or more instructions are run on a computer, the computer performs any of the above-described methods and/or any of the methods disclosed herein.

In another aspect, embodiments of this disclosure provide a non-transitory computer-readable medium storing instruction the instructions causing a processor in a device to implement any of the above-described methods and/or any of the methods disclosed herein.

In another aspect, embodiments of this disclosure provide a device configured to perform any of the above-described methods and/or any of the methods disclosed herein.

In another aspect, embodiments of this disclosure provide a processor, configured to execute instructions to cause a device to perform any of the above-described methods and/or any of the methods disclosed herein.

In another aspect, embodiments of this disclosure provide an integrated circuit configure to perform any of the above-described methods and/or any of the methods disclosed herein.

According to one aspect of this disclosure, there is provided a module comprising: one or more circuits for performing any of the above-described methods and/or any of the methods disclosed herein.

According to one aspect of this disclosure, there is provided one or more processors functionally connected to one or more memories for performing any of the above-described methods and/or any of the methods disclosed herein.

According to one aspect of this disclosure, there is provided an apparatus comprising: one or more processors functionally connected to one or more memories for performing any of the above-described methods and/or any of the methods disclosed herein.

According to one aspect of this disclosure, there is provided an apparatus configured to perform any of the above-described methods and/or any of the methods disclosed herein.

In some embodiments the apparatus comprises one or more units configured to perform any of the above-described methods and/or any of the methods disclosed herein.

According to one aspect of this disclosure, there is provided one or more non-transitory, computer-readable storage media comprising computer-executable instructions, wherein the instructions, when executed, cause at least one processing unit, at least one processor, or at least one circuits to perform any of the above-described methods and/or any of the methods disclosed herein.

According to one aspect of this disclosure, there is provided one or more computer-readable storage media storing a computer program, wherein, when the computer program is executed by an apparatus, the apparatus is enabled to implement any of the above-described methods and/or any of the methods disclosed herein.

According to one aspect of this disclosure, there is provided a computer program product including one or more instructions, wherein, when the instructions are executed by an apparatus, the apparatus is enabled to implement any of the above-described methods and/or any of the methods disclosed herein.

According to one aspect of this disclosure, there is provided a computer program, wherein, when the computer program is executed by a computer, an apparatus is enabled to implement any of the above-described methods and/or any of the methods disclosed herein.

According to one aspect of this disclosure, there is provided a system comprising a node for performing any of the above-described methods and/or any of the methods disclosed herein.

According to one aspect of this disclosure, there is provided an apparatus for implementing any of the above-described methods and/or any of the methods disclosed herein in any possible implementation of the foregoing aspects.

In various embodiments, the system and methods disclosed herein provide various benefits.

For example, by estimating 3D cornea center, Kappa angle, and gaze vector using multiple cameras and one corneal reflection, the system and methods disclosed herein allow simplified hardware design, ease of synchronizing the light and cameras, simplified software algorithms for tracking corneal reflections, flexibility in deciding the spatial position of LED, simple calibration process, simplified and fast calibration, and/or the like.

For example, the conventional one-camera one-glint method uses nine-point calibration, and may take over 20 seconds to complete. In contrary, the two-camera one-glint method disclosed herein uses one-point calibration, and may take five (5) seconds to complete.

In some embodiments, by estimating multiple eye parameters, such as the Kappa angle and the distance between the pupil center and the cornea center, using one-point calibration, the system and methods disclosed herein may be turned to a plurality of single-camera single-corneal-reflection eye-tracking systems running in parallel during eye tracking, and achieve a FOV larger than that of the conventional multi-camera eye-tracking systems. On the other hand, the one-time calibration may be performed based on multiple cameras and a single corneal reflection are used for calibration, thereby providing an accurate and simplified the calibration process (that is, a one-point calibration). Such a combination of large FOV and simplified calibration give rise to a robust eye-tracking system (for example, robust to head movements).

### BRIEF DESCRIPTION OF THE DRAWINGS

For a more complete understanding of the disclosure, reference is made to the following description and accompanying drawings, in which:

FIG. 1 is a schematic diagram of a camera-based eye-tracking system;

FIG. 2 is a schematic diagram showing a simplified hardware structure of the controller of the camera-based eye-tracking system shown in FIG. 1;

FIG. 3 is a schematic diagram showing a simplified software architecture of the controller of the camera-based eye-tracking system shown in FIG. 1;

FIG. 4 is a photo showing an example of corneal reflections in a user's eye caused by a system having five (5) infrared (IR) light-emitting diodes (LEDs);

FIG. 5 is a schematic diagram showing a multi-camera single-corneal-reflection eye-tracking system, according to some embodiments of this disclosure

FIG. 6 is a schematic diagram showing the eye model used in the multi-camera single-corneal-reflection eye-tracking system shown in FIG. 5;

FIG. 7 is a flowchart showing a multi-camera single-corneal-reflection eye-tracking process executed by the multi-camera single-corneal-reflection eye-tracking system shown in FIG. 5, for eye tracking using a single light source and multiple cameras, according to some embodiments of this disclosure;

FIG. 8 is a flowchart showing a one-time calibration process executed by the multi-camera single-corneal-reflection eye-tracking system shown in FIG. 5, for determining the Kappa angle κ using a single light source and multiple cameras, according to some embodiments of this disclosure;

FIG. 9 is a flowchart showing a unified eye-tracking process executed by the multi-camera single-corneal-reflection eye-tracking system shown in FIG. 5, according to some embodiments of this disclosure;

FIG. 10 is a flowchart showing the details of the one-time calibration used in the unified eye-tracking process shown in FIG. 9, according to some embodiments of this disclosure;

FIG. 11 shows an example of a remote eye-tracking system having a single LED and two cameras, according to some embodiments of this disclosure;

FIG. 12 shows another example of a remote eye-tracking system having a single LED and two cameras, according to some embodiments of this disclosure;

FIG. 13 shows another example of a remote eye-tracking system having three LED and three cameras, according to some embodiments of this disclosure;

FIG. 14 shows another example of an eye-tracking system in the form of a head-mounted device, according to some embodiments of this disclosure;

FIGS. 15A to 15D show examples of the views of the two cameras in the eye-tracking system shown in FIG. 14, with one or two corneal reflections in the views of the two cameras; and

FIG. 16 shows yet another example of an eye-tracking system in the form a driver-monitoring system installed in a vehicle, according to some embodiments of this disclosure.

### DETAILED DESCRIPTION

### A. System Structure

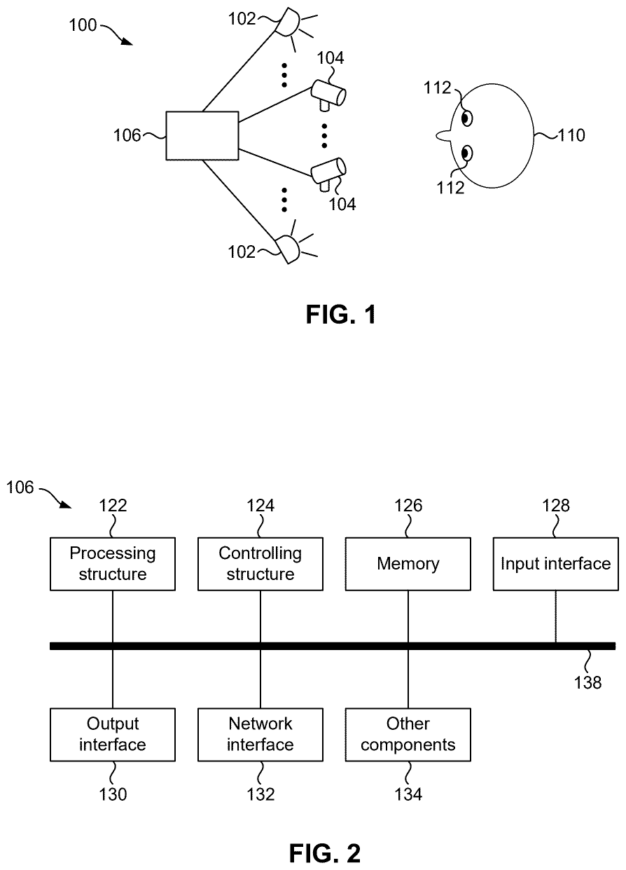

Turning now to FIG. 1, a camera-based eye-tracking system is shown and is generally identified using reference numeral 100. As shown, the eye-tracking system 100 comprises one or more light sources 102 and one or more cameras 104 functionally connecting to one or more controlling circuits 106 (such as one or more controllers) via suitable wired and wireless connections, for tracking one or more eyes 112 of a user 110.

The controller 106 may be any suitable portable and/or non-portable computing device such as laptop computer, tablet, smartphone, personal digital assistant (PDA), virtual reality (VR) headset, augmented reality (AR) goggle, desktop computer, computer server, and/or the like. FIG. 2 is a schematic diagram showing the structure of the controller 106.

As shown, the controller 106 comprises a processing structure 122, a controlling structure 124, one or more non-transitory computer-readable memory or storage devices or media 126, an input interface 128, and an output interface 130, functionally interconnected by a system bus 138. The controller 106 may also comprise a network interface 132 and/or other components 134 coupled to the system bus 138.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, NVIDIA processor, or the like. When the processing structure 122 comprises a plurality of processors, the processors thereof may collaborate via a specialized circuit such as a specialized bus or via the system bus 138.

The processing structure 122 may also or alternatively comprise one or more real-time processors, programmable logic controllers (PLCs), microcontroller units (MCUs), u-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 122 comprises necessary circuitries implemented using technologies such as electrical and/or optical hardware components for executing one or more processes, as the design purpose and/or the use case maybe. For example, the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processing thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 122 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software.

Of course, those skilled the art will appreciate that a process or a function (and thus the processor 122) may be implemented using other technologies such as analog technologies.

Referring back to FIG. 2, the controlling structure 124 comprises one or more controlling circuits, such as graphic controllers, input/output chipsets and the like, for coordinating operations of various hardware components and modules of the controller 106.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like.

The input interface 128 comprises one or more input modules for one or more users to input data via, for example, touch-sensitive screen, touch-sensitive whiteboard, touchpad, keyboards, computer mouse, trackball, microphone, scanners, cameras, and/or the like. The input interface 128 may be a physically integrated part of the controller 106 (for example, the touchpad of a laptop computer or the touch-sensitive screen of a tablet), or may be a device physically separate from, but functionally coupled to, other components of the controller 106 (for example, a computer mouse). The input interface 128, in some implementation, may be integrated with a display output to form a touch-sensitive screen or touch-sensitive whiteboard.

The output interface 130 comprises one or more output modules for output data to a user. Examples of the output modules comprise displays (such as monitors, LCD displays, LED displays, projectors, and the like), speakers, printers, virtual reality (VR) headsets, augmented reality (AR) goggles, and/or the like. The output interface 130 may be a physically integrated part of the controller 106 (for example, the display of a laptop computer or tablet), or may be a device physically separate from but functionally coupled to other components of the controller 106 (for example, the monitor of a desktop computer).

The controller 106 may also comprise a network interface 132, which comprises one or more network modules for connecting to other computing devices or networks by using suitable wired or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (Worldwide Interoperability for Microwave Access (WiMAX), CDMA2000, Long Term Evolution (LTE), 3GPP, fifth-generation New Radio (5G NR) and/or other 5G networks, fifth-generation (6G) networks, and/or the like. In some embodiments, parallel ports, serial ports, USB connections, optical connections, or the like may also be used for connecting other computing devices or networks although they are usually considered as input/output interfaces for connecting input/output devices.

The controller 106 may also comprise other components 134 such as one or more positioning modules, temperature sensors, barometers, inertial measurement unit (IMU), and/or the like.

The system bus 138 interconnects various components 122 to 134 enabling them to transmit and receive data and control signals to and from each other.

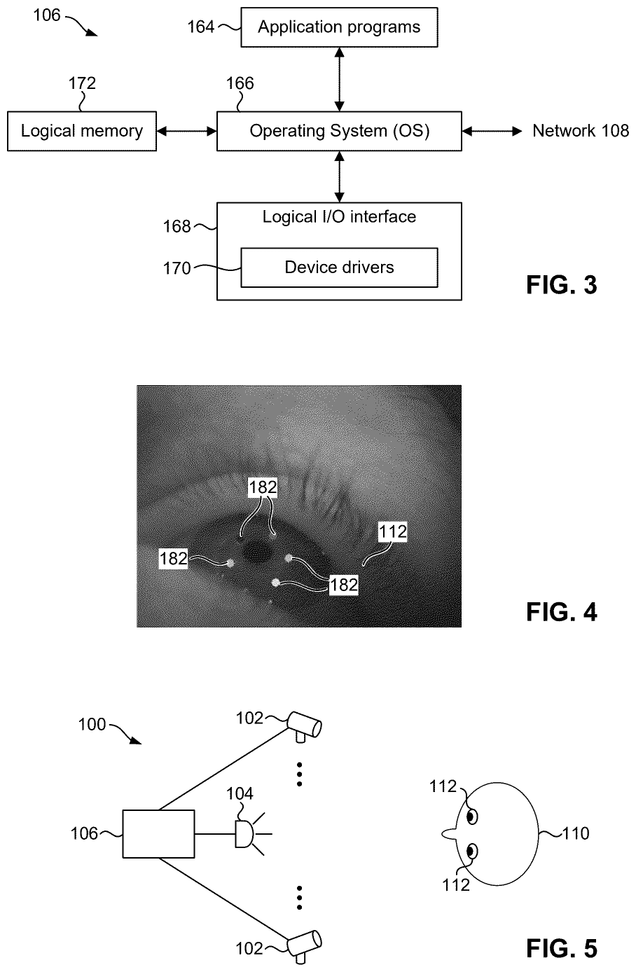

FIG. 3 shows a simplified software architecture of the controller 106. On the software side, the controller 106 comprises one or more application programs 164, an operating system 166, a logical input/output (I/O) interface 168, and a logical memory 172. The one or more application programs 164, operating system 166, and logical I/O interface 168 are generally implemented as computer-executable instructions or code in the form of software programs or firmware programs stored in the logical memory 172 which may be executed by the processing structure 122.

The one or more application programs 164 executed by or run by the processing structure 122 for performing various tasks.

The operating system 166 manages various hardware components of the controller 106 via the logical I/O interface 168, manages the logical memory 172, and manages and supports the application programs 164. The operating system 166 is also in communication with other computing devices (not shown) via the network 108 to allow application programs 164 to communicate with those running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google LLC, Mountain View, CA, USA), or the like.

The logical I/O interface 168 comprises one or more device drivers 170 for communicating with respective input and output interfaces 128 and 130 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 130).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

### B. Eye-Tracking Using Multiple Cameras

As described above, camera-based or video-based eye-tracking or gaze estimation mainly comprises a calibration process and a run-time process. The calibration process involves estimating subject-specific parameters that enhances the performance of the eye tracker. The run-time process is the real time tracking of the gaze direction once the calibration process is done.

Based on the hardware configuration, the eye-tracking system 100 (also called the “eye tracker”) can be classified into two categories: remote system and head-mounted system. In remote system, the eye tracker's hardware components including the one or more light sources 102 and the one or more cameras 104 are placed away from the user 110. On the other hand, the head-mounted eye-tracking system have hardware components placed inside an augmented reality (AR) or virtual reality (VR) head-mounted display, resulting in close proximity with the eyes.

Thus, the eye-tracking system 100 is generally a computer system or a computing device depending on the implementation. As those skilled in the art understand, the processing structure 122 is usually of no use without meaningful firmware and/or software. Similarly, while a computer system or computing device may have the potential to perform various tasks, it cannot perform any tasks and is of no use without meaningful firmware and/or software. As will be described in more detail later, the eye-tracking system 100 described herein and the modules, circuits, and components thereof, as a combination of hardware and software, generally produces tangible results tied to the physical world, wherein the tangible results such as those described herein may lead to improvements to the computer devices and systems themselves, the modules, circuitries, and components thereof, and/or the like.

The one or more light sources 102 and one or more cameras 104 may be any suitable light sources (such as one or more light-emitting diodes (LEDs)) and cameras. Usually, Infrared (IR) cameras and IR LEDs are more preferrable than red-green-blue (RGB) cameras and visible light since IR lights do not interfere with human vision, thereby allowing eye features to be tracked accurately such that the systems can operate in varying environments including nighttime. However visible light may be advantageous in outdoor environments since sunlight casts strong IR lights that may otherwise interfere with the IR-based eye-tracking systems.

LEDs play an important role in an eye-tracking system. One of the primary purposes of using LEDs is to provide even illumination across the captured image which results in increased signal-to-noise ratio (SNR). High SNR means that the captured image is of good quality making the processing of images relatively easier for the gaze algorithms. Another important use of IR/visible-light LEDs is to create corneal reflections.

Corneal reflections are virtual images of the reflections of the light sources 102 (for example, LEDs) on the cornea of the eye 112. Locations of corneal reflections in the captured image are used as one of the most important eye features by state-of-the-art gaze algorithms. FIG. 4 shows an example of corneal reflections 182 in a user's eye 112 caused by a system 100 having five (5) IR LEDs 102. The number of corneal reflections 182 required in the eye image are dependent on the type of gaze algorithm. Based on number of corneal reflections used, gaze estimation algorithms can be divided into three general classes: 1) appearance-based, 2) feature-based and 3) geometrical eye model based.

Appearance-based methods compute gaze position by leveraging machine learning (ML) techniques on images captured by the eye tracker's camera 104. Such methods do not require any information regarding corneal reflections. The best performing appearance-based methods achieve accuracy of 2-3 degrees. Better accuracy with such methods can be achieved by retraining the ML network for every subject, but this may not be practical. Appearance-based techniques, which exhibit relatively poor accuracy, also require large training datasets that may result in significant redesign efforts when the hardware of the eye tracker changes.

Feature based methods make use of single eye feature such as the vector between one corneal reflection and pupil center. Such methods can only estimate two-dimensional (2D) gaze and require a display screen to be present in the system 100.

Geometrical eye-model based methods can achieve better accuracy than the other two categories of gaze methods. Due to the high accuracy and robustness to nominal head movements, variants of this method are seen in use in professional systems.

Geometrical eye-model methods are based on a mathematical model that utilize the estimates of the centers of the pupil and one or more corneal reflections (wherein each corneal reflection is caused by a light source 102) extracted from eye images. The model covers the full range of possible systems that includes one camera 104 and one corneal reflection visible in the eye 112, to the more complex systems that include multiple cameras 104 and multiple corneal reflections (or equivalently multiple light sources 102).

Single camera systems form the simplest configuration of eye trackers. In such systems, variation is seen in terms of number of corneal reflections present in the eye 112. While many systems require multiple corneal reflections in the eye 112 (and thus multiple light sources 102), some of these systems only require one corneal reflection (and thus one light source 102), thereby resulting in larger operating range and reduction in hardware/software complexity. However, such systems have a major drawback which is the requirement of a complex calibration process. Calibration requires the user 110 to look at nine different target points on the screen. This process is tedious as it may take up to 30 seconds to complete and sometimes have to be repeated if the accuracy is subpar during tracking phase.

To overcome this challenge, multi-camera eye trackers 100 have been developed. In such systems, two cameras 104 and at least two corneal reflections (and thus two light sources 102) are required for the system to function. Calibration process is simplified where the user 110 only needs to look at one point on the screen while exhibiting the same accuracy as single-camera eye trackers. However, due to the requirement of multiple corneal reflections to be present in eye images of both the cameras 104, the hardware/software complexity of the system increases while also restricting the operating range of the system 100. To address these challenges, its critical to reduce the dependence on the number of corneal reflections needed to estimate gaze.

For example, geometrical three-dimensional (3D) model-based approach aims to find the visual axis which represents the gaze direction (wherein visual axis is the vector that passes through the 3D cornea center connecting the fovea region of the retina and the object of interest). A prerequisite in the estimation of visual axis is the estimation of optical axis (wherein optical axis is the line connecting 3D pupil center and 3D cornea center). 3D cornea center is computed using different methods depending on the number of corneal reflections and cameras 104 available in the system 100.

In prior art, eye-tracking systems 100 using geometrical 3D model-based approach include systems having one camera and two corneal reflections and systems having multiple camera and multiple corneal reflections. In single-camera systems, 3D pupil center is then estimated using the cornea center and the distance between pupil and cornea center (which is subject dependent). In multiple-camera systems, pupil center is computed using multi-view geometry.

In these systems, a one-time calibration process is performed to find the subject-dependent parameters where users are asked to look at target points on the screen. The single-camera systems require nine-point calibration and need to estimate two subject-specific parameters, that is, the distance between pupil and cornea center and the angle between visual and optical axis. The multi-camera systems require estimation of only angle between visual and optical axis and hence one point calibration is needed.

Single-camera eye trackers have proven to work well in different scenarios but have a complex calibration process. Multi-camera eye tracking systems allow for simpler calibration process while exhibiting same performance but require the need for multiple corneal reflections to be present in the eye images of the multiple cameras to estimate the 3D cornea center at all times. Corneal reflections are not guaranteed to be present in the eye especially during run-time due to various factors. Even if corneal reflections are present, it may be challenging to accurately track and match corneal reflections with their corresponding LEDs 102. This results in highly sensitive eye-tracking system with a limited operating range.

While the above-described problem can be solved by reducing the dependence on the number of LEDs 102, a multi-camera eye-tracker 100 usually has a smaller operating range compared to a single-camera system. A lower operating range limits the use of eye trackers in practical settings. Single-camera eye-trackers on the other hand have a complex calibration process. Previous methods have tried to address this issue by combining the multi-camera and single-camera eye-trackers into a single system. However, such systems require the presence of multiple corneal reflections which increases the hardware and/or software complexity of the system and may not expand the operating range to a level that is needed.

In the following, various embodiments of a multi-camera eye-tracking system and method that uses one corneal reflection are disclosed. The multi-camera single-corneal-reflection eye-tracking system and method disclosed herein solve one or both of the following two problems:
(1) having the multi-camera eye-tracking system work with one corneal reflection; and
(2) combining the advantages of single- and multi-camera eye trackers into a unified eye tracking system that uses one corneal reflection.

Existing multi-camera eye trackers have a limited operating range compared to single-camera eye trackers. By combining the advantages of single- and multi-camera eye trackers, the multi-camera single-corneal-reflection eye-tracking system and method disclosed herein may achieve a large operating range and simple calibration process.

More specifically, in the multi-camera single-corneal-reflection eye-tracking system and method disclosed herein, the calibration process utilizes the multi-camera approach while in the tracking phase, the multi-camera system is split into two single-camera eye trackers, thereby achieving the advantages of single- and multi-camera systems in one unified eye tracker.

FIG. 5 is a schematic diagram showing a multi-camera single-corneal-reflection eye-tracking system 100, according to some embodiments of this disclosure. As shown, the multi-camera single-corneal-reflection eye-tracking system 100 in these embodiments comprises a single light source 102 for emitting light towards one or more eyes 112 of the user 110, and a plurality of cameras 104 (such as two cameras 104) positioned away from the user 110 and facing the one or more eyes 112 of the user 110 at different angles. The light source 102 and the plurality of cameras 104 are functionally connected to one or more controllers 106.

The light source 102, the cameras 104, and the one or more controllers 106 are similar to those shown in FIG. 1. Depending on the implementation, the multi-camera single-corneal-reflection eye-tracking system 100 may be a system having physically separated items (for example, some or all of the light source 102, the cameras 104, and the one or more controllers 106 are physically separated apparatuses or items in the system 100), or may be an apparatus with all components (for example, the light source 102, the cameras 104, and the one or more controllers 106) integrated therein.

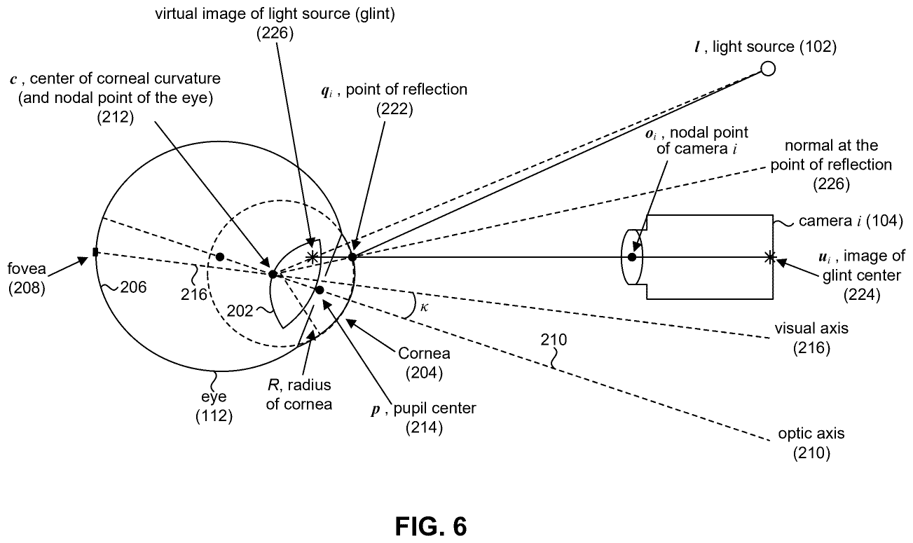

FIG. 6 is a schematic diagram showing the eye model used in the multi-camera single-corneal-reflection eye-tracking system 100. As shown, the eye 112 comprises a crystalline lens 202 behind the cornea 204, and a retina 206 on the rear wall of the eye 112. The retina 206 has a fovea 208 which is a point with the highest visual acuity. The line 210 between the center of corneal curvature 212 (denoted as c; also called the “nodal point” or the “cornea center” of the eye 112) and the pupil center 214 (denoted as p) defines the optic axis. The line 216 between the fovea 208 and the cornea center c defines the visual axis 216 (that is, the gaze vector), which extends to the target point that the user 110 is looking at. The angle between the optic axis 210 and the visual axis 216 is denoted the Kappa angle κ.

Herein, a point (such as the cornea center c, the pupil center p, and other points described below) may be considered a vector in a 3D coordinate system, and is represented in bold font.

When the camera-based eye-tracking system 100 shown in FIG. 6 is used, the light source 102 emits light ray towards the eye 112 and the plurality of cameras 104 capture images of the eye 112. The light source 102 is positioned at point l. The light from the light source l is reflected on the surface of the cornea 204 at the point of reflection 222 (denoted as qᵢ), and is captured by the i-th camera 104 at the point 224 (denoted as uᵢ, also called the “imaged glint” or “glint center”) of the captured image thereof. Thus, the point uᵢ of the captured image of the i-th camera 104 represents the virtual image 226 (also called the “glint”) of the light source l in the eye 112, viewing from the i-th camera 104. The normal 226 at the point of reflection is identified using reference numeral 226. The nodal point 228 of the i-th camera 104 is denoted oᵢ.

The reflection point 222, the glint center 224, and the nodal point 228 of cameras 104 are collinear resulting in the following set of equation:

$${q}_{i} = {o}_{i} + {k}_{q i} \frac{{o}_{i} - {u}_{i}}{‖ {o}_{i} - {u}_{i} ‖} \qquad ( 1 )$$

where “∥·∥” represents the vector norm, i=1, 2, . . . , k_{qi} represents the distance between the point of reflection qᵢ and the nodal point oᵢ of the i-th camera, and uᵢ is the position of the corneal reflections in images obtained by the i-th camera.

Any point qᵢ on the surface of the cornea 204 satisfies:

$$R = ‖ {q}_{i} - c ‖ \qquad ( 2 )$$

where R is the radius of the cornea 202.

Since the incident ray from each light source 102, the reflected ray from the surface of the cornea 204, and the normal 226 at the point of reflection are at the same plane, the following scalar equation can be written:

$$( l - {o}_{i} ) \times ( {q}_{i} - {o}_{i} ) \cdot ( c - {o}_{i} ) = 0 \qquad ( 3 )$$

where “x” represents vector cross-product, and “·” represents vectors dot-product.

Using Equation (1), (qᵢ−oᵢ) and (oᵢ−uᵢ) are along the same line; thus Equation (3) is equivalent to:

$$( l - {o}_{i} ) \times ( {o}_{i} - {u}_{i} ) \cdot ( c - {o}_{i} ) = 0 \qquad ( 4 )$$

Since at the point of reflection qᵢ, the angle between the incident ray and the normal 226 to the surface of the cornea 204 is equal to the angle between the reflected ray and the normal 226 to the surface of the cornea 204 the following scalar equation can be written:

$$( \frac{l - {q}_{i}}{‖ l - {q}_{i} ‖} - \frac{{o}_{i} - {q}_{i}}{‖ {o}_{i} - {q}_{i} ‖} ) \cdot ( {q}_{i} - c ) = 0 \qquad ( 5 )$$

Note that |qᵢ−c|=R, where R is the radius of the cornea 202. Then, Equation (5) becomes:

$$\vert \frac{l - {q}_{i}}{‖ l - {q}_{i} ‖} - \frac{{o}_{i} - {q}_{i}}{‖ {o}_{i} - {q}_{i} ‖} \vert R cos θ = 0 \qquad ( 6 )$$

where θ is the angle between the vector

$$( \frac{l - {q}_{i}}{‖ l - {q}_{i} ‖} - \frac{{o}_{i} - {q}_{i}}{‖ {o}_{i} - {q}_{i} ‖} )$$

and the vector (qᵢ−c). Also note that qᵢ may be calculated using Equation (1). Therefore, the vector c (that is, the cornea center 212 of the eye 112) may be calculated using l (the position of the light source 102), oᵢ (the position of the nodal point of the i-th camera 104), k_{qi} (the distance between the point of reflection qᵢ and the nodal point oᵢ of the i-th camera), uᵢ (the position of the glint center 224), and R (the radius of the cornea 202), wherein the parameters of the light source 102 and cameras 104 (that is, l and oᵢ) are known, and uᵢ may be obtained by measuring the glint center 224 in the eye image captured by the i-th camera. Therefore, the vector c is a function of k_{qi} and R, that is:

$${c}_{i} = {c}_{i} ( {k}_{qi} , R ) \qquad ( 7 )$$

where cᵢ represents the vector c calculated from parameters related to the i-th camera, and the function cᵢ(k_{qi}, R) is determined based on Equations (1) and (5). In other words, the function cᵢ(k_{qi}, R) is determined based on:

$$( \frac{l - {q}_{i}}{‖ l - {q}_{i} ‖} - \frac{{o}_{i} - {q}_{i}}{‖ {o}_{i} - {q}_{i} ‖} ) \cdot ( {q}_{i} - {c}_{i} ) = 0 \qquad ( 8 )$$

for i=1, 2, . . . , N, and

$${q}_{i} = {o}_{i} + {k}_{qi} \frac{{o}_{i} - {u}_{i}}{‖ {o}_{i} - {u}_{i} ‖} \qquad ( 9 )$$

Then, using the above set of equations, coordinates of c can be computed by finding the optimal values of k_{qi} and R such that cᵢ (i=1, 2, . . . ) converge to an optimum point c. Note that the term “converge” does not necessarily mean that all c; would become the same point after optimization. Rather, this term means that, after the optimization, the points cᵢ are at or closest to the optimum point c̅ under certain optimization criteria.

In various embodiments, various suitable optimization methods may be used. For example, the optimum point c̅ may be obtained by finding the optimal values of k_{qi} and R such that the sum of the squares of the distances between cᵢ pairs is minimized. Alternatively, the optimum point c̅ may be obtained by finding the optimal values of k_{qi} and R such that the sum of the squares of the distances between cᵢ and the geometry center of all cᵢ is minimized.

For example, in the embodiments wherein two cameras are used, the optimum point c̅ may be found by computing:

$${min}_{{k}_{q 1} , {k}_{q 2} , R} ‖ {c}_{1} ( {k}_{q 1} , R ) - {c}_{2} ( {k}_{q 2} , R ) ‖ \qquad ( 10 )$$

Then, the cornea center c is obtained by averaging the two cornea centers c₁ and c₂ obtained from the two cameras 104 and one light source 102 as:

$$c = \frac{{c}_{1} ( {k}_{q 1} , R ) + {c}_{2} ( {k}_{q 2 ,} R )}{2} \qquad ( 11 )$$

Once the cornea center c is obtained, the pupil center 214 or p is obtained using any suitable 3D pupil estimation method, for the method described in academic paper entitled “Remote Point-of-Gaze Estimation Requiring a Single-Point Calibration for Applications with Infants,” by Guestrin, et al. published on ETRA'08: Proceedings of the 2008 symposium on Eye tracking research & applications Pages 267-274, the content of which is incorporated herein by reference in its entirety. The optical axis 210 (that is, the line 210 between the cornea center c and the pupil center p) is obtained. The Kappa angle κ between the optical axis 210 and the visual axis 216 may be estimated using a one-time calibration process.

For example, during the one-time calibration process, the user 110 is asked to look at a single target point at a known position (such as displayed at a known position on a physical or virtual screen). While the user is gazing at the known target point, one or more sets of face or eye images are captured by the multiple cameras 104 wherein each image set comprises an eye image captured by each of the multiple cameras 104. For every image set, eye features are extracted, and the cornea center c and the pupil center p are computed as described above. The optical axis 210 is then determined using the cornea center c and the pupil center p, and the gaze vector or visual axis 216 is determined using the cornea center c and the target point (which is at known position). The Kappa angle x between the optical axis 210 and the visual axis 216 is then estimated as the angle between the optical axis 210 and the visual axis 216.

In some embodiments, the multiple cameras 104 may capture multiple image sets during the one-time calibration process such that the captured multiple image sets may be used for minimizing the error between actual and calculated gaze vector.

In the run-time process, the optical axis 210 is calculated in real-time as described above, and the gaze vector 216 (that is, the visual axis) is determined using the calculated optical axis 210 and the Kappa angle κ estimated at the calibration process.

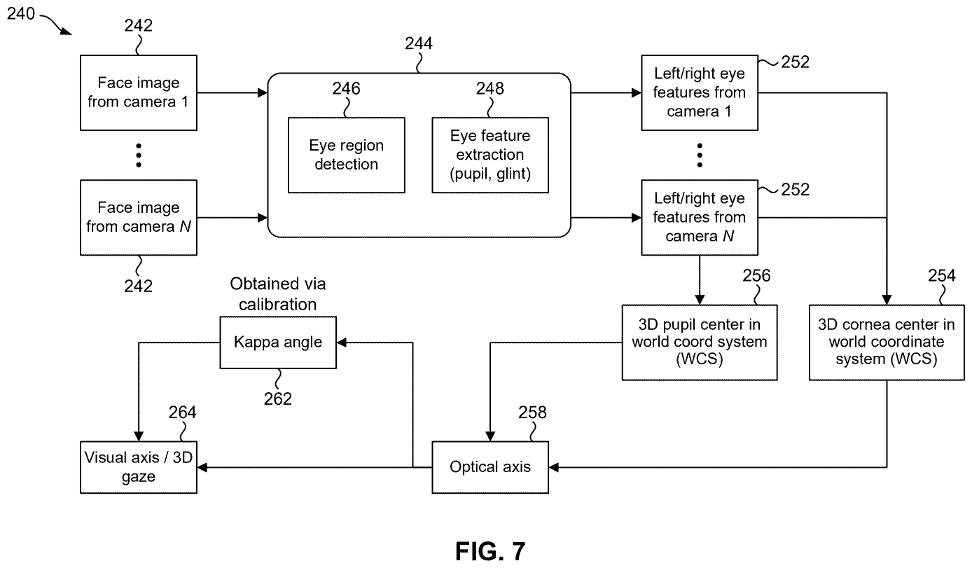

FIG. 7 is a flowchart showing a multi-camera single-corneal-reflection eye-tracking process 240 executed by the system 100 for eye tracking using a single light source 102 and multiple cameras 104 (such as N cameras), according to some embodiments of this disclosure. In other words, the multi-camera single-corneal-reflection eye-tracking tracks gaze vector of one or both eyes 112 of a user 110 using two or more cameras based on a single corneal reflection and without using any other corneal reflections.

In these embodiments, the multi-camera single-corneal-reflection eye-tracking process 240 first estimates the optical axis 210. A one-time calibration process is used to estimate the Kappa angle κ. Then, the visual axis 216 (which represents the gaze direction) is calculated using the optical axis 210 and the Kapp angle κ.

At step 242, each of the multiple cameras 104 takes a face or eye image of the user 110. The eye images are then processed (step 244) by detecting the eye region (step 246) and extracting the eye features such as the pupil, the glint, and the like (step 248).

The eye features 252 extracted from the N images are used to calculate the cornea center c in a suitable 3D coordinate system such as the world coordinate system (WCS) as described above (step 254). The eye features 252 extracted from one or more of the N images are also used to calculate the pupil center p in the 3D coordinate system such as the WCS as described above using a suitable 3D pupil estimation method (step 256). At step 258, the optical axis 210 is then determined using the cornea center c and the pupil center p.

As described above, the Kappa angle κ (also identified as 262) is estimated at the one-time calibration process. At step 264, the optical axis 210 and the Kappa angle x are used to determine the visual axis or gaze vector 216 for eye tracking.

The process 240 is repeatedly executed for tracking the eye moment of the user 110.

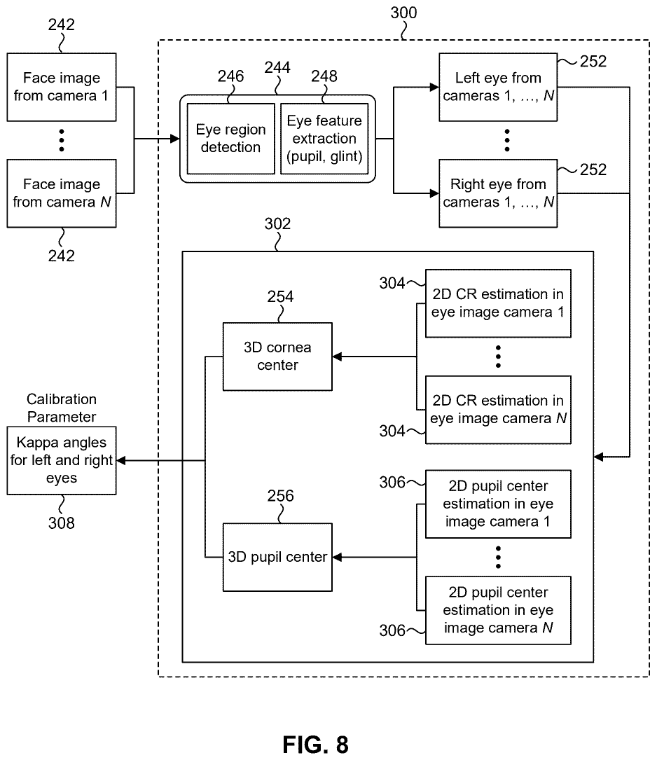

FIG. 8 is a flowchart showing a one-time calibration process 300 executed by the system 100 for determining the Kappa angle κ using a single light source 102 and multiple cameras 104 (such as N cameras), according to some embodiments of this disclosure.

During the one-time calibration process, the user 110 is asked to look at a single target point at a known position (such as displayed at a known position on a physical or virtual screen). While the user is gazing at the known target point, one or more sets of images are captured by the multiple cameras 104 wherein each image set comprises an image captured by each of the multiple cameras 104 (step 242).

At step 242, each of the multiple cameras 104 takes a face or eye image of the user 110. The eye images are then processed (step 244) by detecting the eye region (step 246) and extracting the eye features such as the pupil, the glint, and the like (step 248).

The eye features 252 extracted from the N images are then analyzed (step 302). More specifically, the extracted eye features 252 are used for estimating the 2D corneal reflection (CR) in the eye image of each camera 104 (which is the 3D glint center uᵢ in the eye image of each camera 104) (step 304), and for estimating the 2D pupil center in the eye image of each camera 104 (which is the 3D pupil center p in the eye image of each camera 104) (step 306). Then, the 3D cornea center c and the 3D pupil center p are estimated as described above (steps 254 and 256, respectively).

Then, the optical axis 210 is determined using the cornea center c and the pupil center p, and the gaze vector or visual axis 216 is determined using the cornea center c and the target point (which is at known position). The Kappa angle x between the optical axis 210 and the visual axis 216 is then estimated as the angle between the optical axis 210 and the visual axis 216 (step 308).

In some embodiments, the multiple cameras 104 may capture multiple image sets during the one-time calibration process such that the captured multiple image sets may be used for minimizing the error between actual and calculated gaze vector.

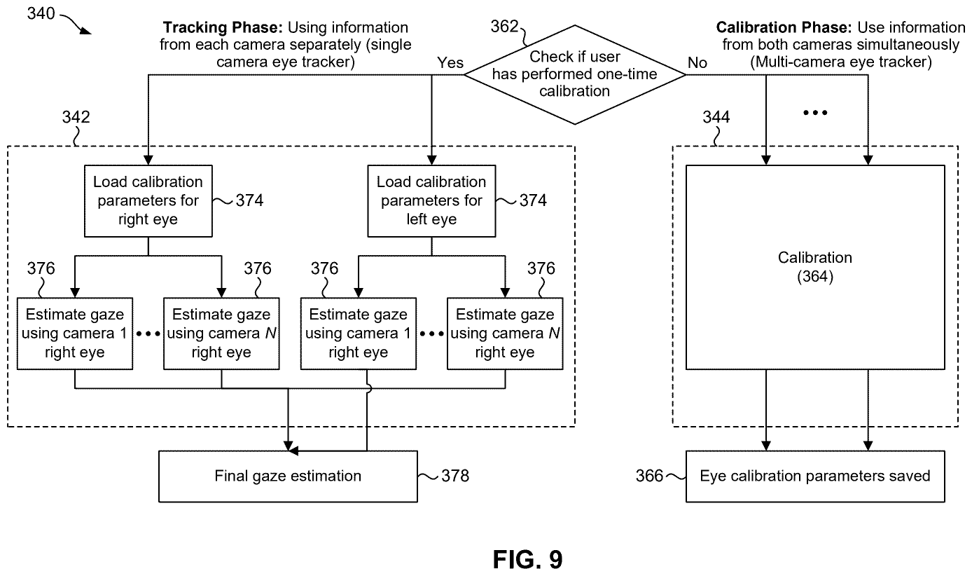

FIG. 9 is a flowchart showing a unified eye-tracking process 340 executed by the system 100, according to some embodiments of this disclosure. In these embodiments, the system 100 uses the single light source 102 and multiple cameras 104 (such as N cameras) for calibration in a calibration phase 342 (wherein Use information from both cameras simultaneously), and uses single light source 102 and single camera 104 for eye tracking in a run-time tracking phase 344.

At step 362, the unified eye-tracking process 340 checks if user 110 has performed the one-time calibration. If no calibration is performed, the unified eye-tracking process 340 goes into the calibration phase 342 to perform a one-time calibration (step 364; described in more detail later). The obtained eye calibration parameters are saved (step 366).

If at step 362, it is determined that the one-time calibration has been performed, the unified eye-tracking process 340 goes into the run-time tracking phase 344 to tracking the user's eye movement.

In the run-time tracking phase 344, the calibration parameters for the left and/or right eyes are loaded (step 374). Each camera 104 is separately and individually used for estimating the gaze vector 216 of each eye 112 based on the images captured by that camera (step 376) and without using the information of images captured by other cameras. Thus, in the run-time tracking phase 344, the multi-camera single-corneal-reflection eye-tracking system 100 becomes a plurality of single-camera single-corneal-reflection eye-tracking systems running in parallel, which results in an increased operating range of the system 100 while maintaining the same level of accuracy as the multi-camera single-corneal-reflection eye-tracking process 240 shown in FIG. 7. As the system 100 has N cameras 104, N gaze vectors are obtained for each eye 112 at step 376. At step 378, the N gaze vectors are combined to obtain a final gaze estimation. For example, the N gaze vectors may be averaged to obtain a final gaze vector.

The run-time tracking phase 344 may be repeatedly performed to track the user's eye movement.

At step 376, each single-camera single-corneal-reflection eye-tracking system may use a suitable eye-tracking method to estimate the gaze vector 216 of each eye 112, such as by using the eye-tracking method disclosed in PCT Patent Application No. PCT/CA2022/051410, entitled “METHODS AND SYSTEMS FOR GAZE TRACKING USING ONE CORNEAL REFLECTION” to Soumil, et al., published on Mar. 28, 2024, the content of which is incorporated herein by reference in its entirety.

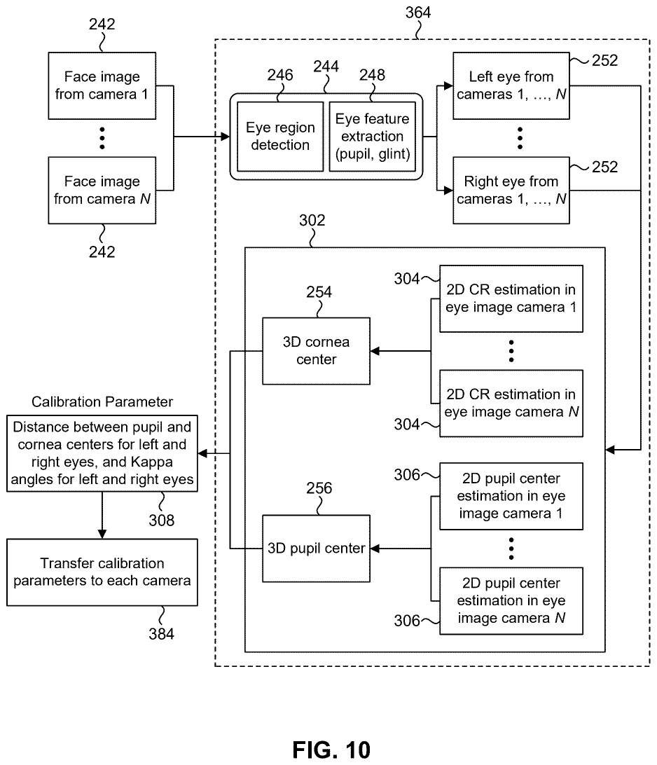

Unlike the one-time calibration 300 shown in FIG. 8 used in the multi-camera single-corneal-reflection eye-tracking process 240 shown in FIG. 7, which only estimates the Kappa angle κ, the one-time calibration 364 in these embodiments needs to estimate two eye parameters, including: (a) the distance between pupil center p and cornea center c, and (b) the Kappa angle κ, to ensure the operation of each single-camera single-corneal-reflection eye-tracking system at step 376. FIG. 10 shows the details of the one-time calibration 364 in these embodiments.

The one-time calibration process 364 is similar to the one-time calibration process 300 shown in FIG. 8 except that except that, at step 308, the distance d between pupil center p and cornea center c for each eye, and the Kappa angle κ for each eye are calculated.

In some embodiments, the one-time calibration process 364 may be repeated performed when user is gazing at the single target point, and then the distances d obtained from multiple image frames for each eye are averaged, which is used as the final distance d between pupil center p and cornea center c.

At step 384, the calibration parameters such as the distance d and the Kappa angle κ are transferred to each camera 104 for the single-camera single-corneal-reflection eye-tracking to function properly.

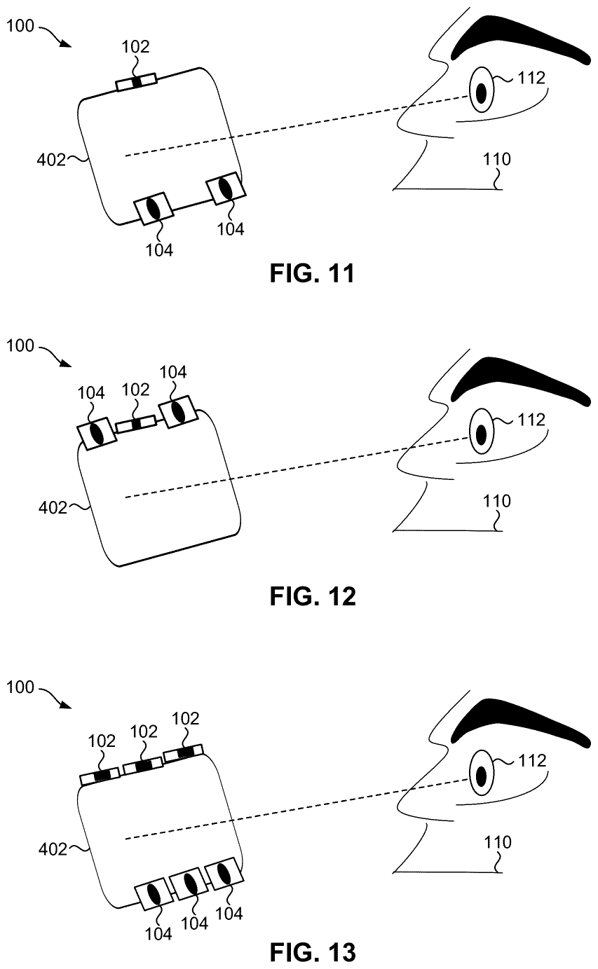

The multi-camera single-corneal-reflection eye-tracking system 100 disclosed herein may be used in various applications. For example, FIG. 11 shows an example of a remote eye-tracking system 100 having a single LED 102 and two cameras 104. The LED 102 and two cameras 104 are placed far away from the user 110. An optional display screen 402 is also present in the system 100 for screen-based interaction. In this example, the LED 102 is located above the screen 402 and the two cameras 104 are located below the screen 402.

Such a system 100 may be used in portable devices such as mobile phones, smartphone, tablets, laptops, and/or the like, and may be used in desktop computing devices for use as an accessibility interface, for general purpose applications such as gaming and advertising, and/or for any other suitable purposes.

In this example, the cameras 104 may be IR cameras, IR/RGB camera modules (wherein an IR/RGB camera module is a single sensor that can capture both IR and RGB images), a combination of IR and IR/RGB camera modules, or the like.

RGB cameras have an advantage of working under varying ambient lighting conditions especially under sunlight.

On the other hand, IR/RGB camera modules may provide flexible options such as:
(i) using IR and RGB cameras for both calibration and run-time, or
(ii) using IR cameras for calibration while using IR and RGB cameras for tracking.

In option (i), the LED 102 may be a bi-spectral LED that emits both IR and visible light. In option (ii), the IR LED may only be used for calibration, and eye-tracking may be based on RGB images using a model-based glint-free method such as the method disclosed in U.S. patent application Ser. No. 18/524,640, “METHODS AND SYSTEMS FOR GAZE TRACKING AND GAZE TRACKING CALIBRATION,” to Soumil, et al., filed on Nov. 30, 2023, the content of which is incorporated herein by reference in its entirety.

In accordance with the type of the cameras 104, the LED 102 may be an IR LED or an IR/visible light module producing one glint in the eye images of the two cameras 104.

In this example, the one-time calibration is based on two cameras 104 and a single light source 102 (or equivalently, a single glint). The eye-tracking may be based on two cameras 104 and one glint, or based on one camera and one glint.

FIG. 12 shows another example of a remote eye-tracking system 100 having a single LED 102 and two cameras 104. The remote eye-tracking system 100 in this example is similar to that shown in FIG. 11 except that the LED 102 and the two cameras 104 are located above the screen 402.

FIG. 13 shows yet another example of a remote eye-tracking system 100 having multiple LEDs 102 (such as three LEDs 102) and multiple cameras 104 (such as three cameras 104). In this example, the three LEDs 102 are located above the screen 402 and the three cameras 104 are located below the screen 402. The light emitted from each of the three LEDs 102 is visible or otherwise detectable by all three cameras 104.

While the remote eye-tracking system 100 comprises three LEDs 102, these LEDs 102 do not emit light at the same time. Rather, the three LEDs 102 may alternately or sequentially emit light at different time instants, thereby forming three eye-tracking systems each having three cameras 104 and a single LED 102 (causing a single corneal-reflection in each eye 112). Each of the three-camera single-LED system may operate separately and individually as described above. Then, the gaze vectors estimated by the multiple three-camera single-LED systems may be combined for improving the eye-tracking accuracy.

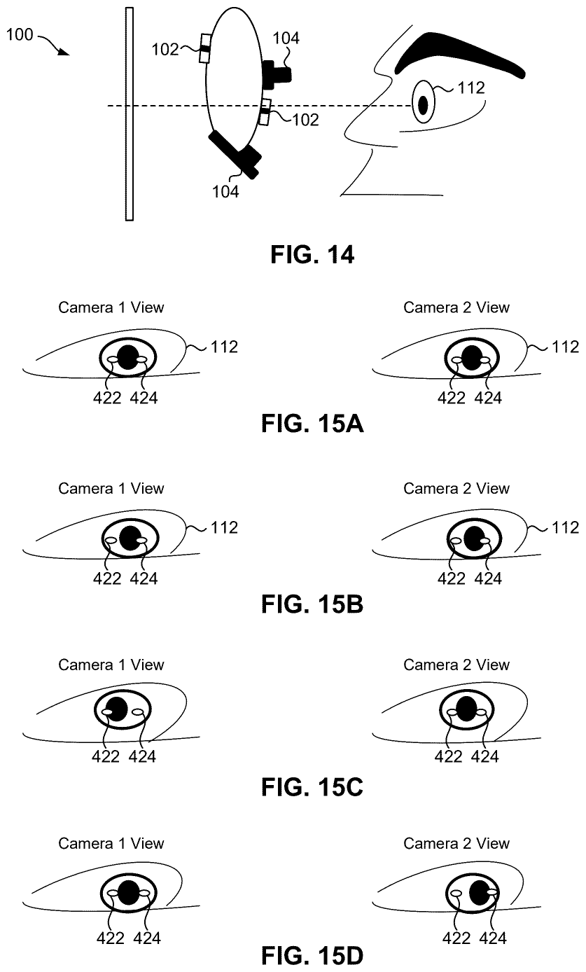

FIG. 14 shows still another example of a head-mounted eye-tracking system 100 (such as a head-mounted device). In this example, the head-mounted eye-tracking system 100 comprises two IR LEDs 102 and two IR cameras 104 placed around each of the user's eye 112. The head-mounted eye-tracking system 100 may be used in various applications such as general-purpose human-computer interaction, foveated rendering, pilot training, diagnosis of mental health disorders, gaming, and/or the like. The operation of the eye-tracking and calibration is similar to that shown in FIG. 13.

Due to the close proximity of the physical components of the head-mounted eye-tracking system 100, the two IR LEDs 102 provide even illumination across the captured images. Moreover, when the two IR LED 102 are turned on to emit light, the two IR LEDs 102 causes at least one corneal reflection for all eye positions.

For example, as shown in FIG. 15A, when the two IR LED 102 are turned on to emit light, and the eye 112 is in a first position, the two IR LEDs 102 causes two corneal reflections 422 and 424 in each of the two cameras 104.

As shown in FIG. 15B, when the two IR LED 102 are turned on to emit light, and the eye 112 is in a second position, the two IR LEDs 102 causes a single corneal reflection 424 in each of the two cameras 104. The other reflection 422 is not a corneal reflection and thus is useless for eye-tracking or calibration.

As shown in FIG. 15C, when the two IR LED 102 are turned on to emit light, and the eye 112 is in a third position, the two IR LEDs 102 causes two corneal reflections 422 and 424 in camera 2, and camera 1 sees a single corneal reflection 422 (the other reflection 424 is not a corneal reflection).

As shown in FIG. 15D, when the two IR LED 102 are turned on to emit light, and the eye 112 is in a fourth position, the two IR LEDs 102 causes two corneal reflections 422 and 424 in camera 1, and camera 2 sees a single corneal reflection 424 (the other reflection 422 is not a corneal reflection).

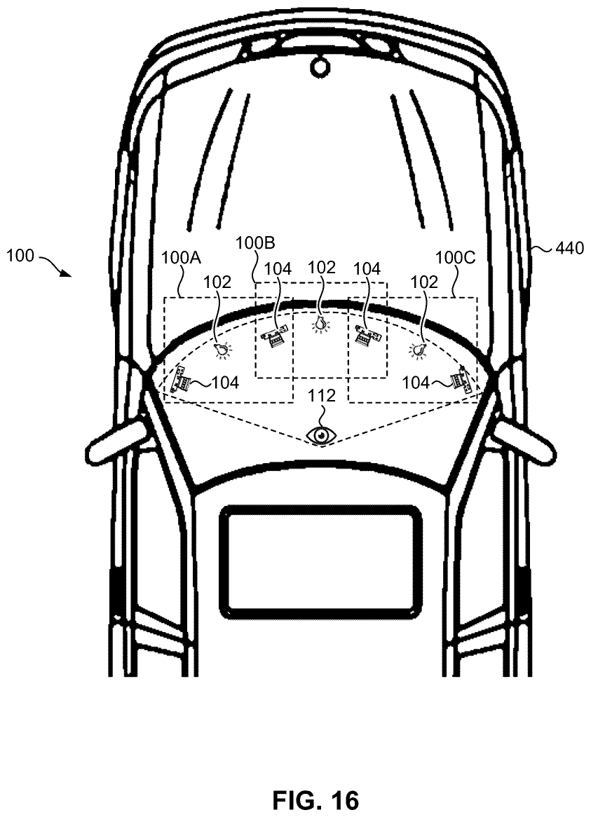

FIG. 16 shows another example of an eye-tracking system 100 in the form a driver-monitoring system installed in a vehicle 440. The eye-tracking system 100 in this example comprises multiple lights 102 (such as three lights 102) and multiple cameras 104 (such as four cameras 104) distributed in front of the driver (represented by the eye 112) inside the cockpit of the vehicle 440, for tracking the driver's attention and for general-purpose interaction with the infotainment system.

The multiple lights 102 and multiple cameras 104 form a plurality of multi-camera single-light (or single-corneal-reflection) eye-tracking systems 100A to 100C for covering a large field of view (FOV). In the embodiments shown in FIG. 16, each multi-camera single-light eye-tracking system 100A to 100C may comprise its own light 102 and cameras 104. In some other embodiments such as the example shown in FIG. 16), one or more of the lights 102 and/or one or more of the cameras 104 may be shared by two or more of the multi-camera single-light eye-tracking systems 100A to 100C.

In some embodiments, the lights 102 and the cameras 104 are configured in such a way that each light 102 in a multi-camera single-light eye-tracking system causes a glint in the eye only visible to the cameras 102 of the same multi-camera single-light eye-tracking system, and invisible to the cameras 102 of other multi-camera single-light eye-tracking systems, thereby ensuring each multi-camera single-light eye-tracking system to operate properly.

In some other embodiments, each multi-camera single-light eye-tracking system may alternately or sequentially operate such that the lights 102 in different multi-camera single-light eye-tracking systems may alternately or sequentially emit light at different time instants, thereby ensuring each multi-camera single-light eye-tracking system to operate properly.

The operation of the eye-tracking and calibration in this example is similar to that shown in FIG. 13.

The multi-camera single-corneal-reflection eye-tracking system and methods disclosed herein provide various advantages.

For example, by estimating 3D cornea center, Kappa angle, and gaze vector using multiple cameras and one corneal reflection, the multi-camera single-corneal-reflection eye-tracking system and methods disclosed herein allow simplified hardware design, ease of synchronizing the light and cameras, simplified software algorithms for tracking corneal reflections, flexibility in deciding the spatial position of LED, simple calibration process, simplified and fast calibration, and/or the like.

For example, the conventional one-camera one-glint method uses nine-point calibration, and may take over 20 seconds to complete. In contrary, the two-camera one-glint method disclosed herein uses one-point calibration, and may take five (5) seconds to complete.

In some embodiments, by estimating multiple eye parameters, such as the Kappa angle and the distance between the pupil center and the cornea center, using one-point calibration, the multi-camera single-corneal-reflection eye-tracking system disclosed herein may be turned to a plurality of single-camera single-corneal-reflection eye-tracking systems running in parallel during eye tracking, and achieve a FOV larger than that of the conventional multi-camera eye-tracking systems. On the other hand, the one-time calibration may be performed based on multiple cameras and a single corneal reflection are used for calibration, thereby providing an accurate and simplified the calibration process (that is, a one-point calibration). Such a combination of large FOV and simplified calibration give rise to a robust eye-tracking system (for example, robust to head movements).

### C. Acronyms, Abbreviations, and Definition of Some Terms

| Full Name | Acronym/Abbreviation/Initialism |
|---|---|
| Infrared | IR |
| Machine Learning | ML |
| Corneal Reflection | CR |

Herein, the term “gaze estimation” refers to the determination of where a user is looking at on a two-dimensional (2D) screen or in a three-dimensional (3D) physical space.

The term “eye tracking” and “gaze tracking” refer to tracking eye movements and determining where a user is looking on a 2D screen or in a 3D physical space.

The term “gaze vector” refers to the direction in which the user is looking at.

The term “gaze point” refers to the 2D location on the screen where the user is looking at.

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured by a suitable apparatus before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

In some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the various embodiments and/or features disclosed herein may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A computerized method comprising:
performing a first set of actions;
performing a second set of actions based on said performing the first set of actions;
estimating one or more calibration parameters based on said performing the second set of actions; and
performing a third set of actions to track an eye of a user in a three-dimensional (3D) coordinate system based on the one or more calibration parameters;
wherein the first set of actions comprise:
obtaining a plurality of images of the eye taken from different viewing angles, and
detecting a single imaged glint in the 3D coordinate system from each of the plurality of images thereby obtaining a plurality of imaged glints in the 3D coordinate system, each imaged glint corresponding to a position at which a light emitted from a light-emitting position and reflected by a cornea of the eye is captured in the corresponding image of the plurality of images;
wherein the second set of actions comprise:
determining a cornea center of the eye in the 3D coordinate system based on the imaged glints,
determining a pupil center of the eye in the 3D coordinate system based on at least one of the plurality of images, and
determining a first direction in the 3D coordinate system based on the cornea center and the pupil center; and
wherein said estimating the one or more calibration parameters comprises:
determining a second direction in the 3D coordinate system based on the cornea center and a target point in the 3D coordinate system, and
determining a Kappa angle in the 3D coordinate system between the first direction and the second direction as one of the one or more calibration parameters.

2. The method of claim 1, wherein said determining the cornea center comprises:
for each image of the plurality of images, calculating a center of corneal curvature in the 3D coordinate system, thereby obtaining a plurality of centers of corneal curvature; and
finding an optimal value of the first distance and an optimal value of the radius such that the centers of corneal curvature substantially converge to a converged point, the converged point being the cornea center;
wherein for each image of the plurality of images, the calculation of the center of corneal curvature in the 3D coordinate system is based on:
the light-emitting position,
a nodal point in the 3D coordinate system corresponding to capturing of the image,
a first distance between a point of reflection on the eye corresponding to the image, and the nodal point corresponding to the capturing of the image,
an imaged glint of the plurality of imaged glints corresponding to the image, and
a radius of the cornea of the eye.

3. The method of claim 1, wherein said determining the cornea center comprises:
finding optimal values of k_{qi} and R such that cᵢ (i=1, 2, . . . , N) substantially converge to an optimum point c̅, wherein cᵢ is determined based on:
$$( \frac{l - {q}_{i}}{‖ l - {q}_{i} ‖} - \frac{{o}_{i} - {q}_{i}}{‖ {o}_{i} - {q}_{i} ‖} ) \cdot ( {q}_{i} - {c}_{i} ) = 0$$
for i=1, 2, . . . , N, and
$${q}_{i} = {o}_{i} + {k}_{q i} \frac{{o}_{i} - {u}_{i}}{‖ {o}_{i} - {u}_{i} ‖}$$
where:
l is the light-emitting position,
oᵢ is an i-th nodal point in the 3D coordinate system corresponding to capturing an i-th image of the plurality of images,
k_{qi} is a first distance between a point of reflection on the eye corresponding to the i-th image, and the i-th nodal point,
uᵢ is an i-th imaged glint of the plurality of imaged glints, and
R is a radius of the cornea of the eye.

4. The method of claim 1, wherein the plurality of images are two images; and wherein said determining the cornea center comprises:
computing:
$${min}_{{k}_{q 1} , {k}_{q 2} , R} ‖ {c}_{1} ( {k}_{q 1} , R ) - {c}_{2} ( {k}_{q 2} , R ) ‖$$
where c₁(k_{q1}, R) indicates that c₁ is a function of k_{q1} and R, c₂(k_{q2}, R) indicate that c₂ is a function of k_{q2} and R, and c₁ and c₂ are determined based on:
$$( \frac{l - {q}_{1}}{‖ l - {q}_{1} ‖} - \frac{{o}_{1} - {q}_{1}}{‖ {o}_{1} - {q}_{1} ‖} ) \cdot ( {q}_{1} - {c}_{1} ) = 0$$
$$( \frac{l - {q}_{2}}{‖ l - {q}_{2} ‖} - \frac{{o}_{2} - {q}_{2}}{‖ {o}_{2} - {q}_{2} ‖} ) \cdot ( {q}_{2} - {c}_{2} ) = 0$$
$$and$$
$${q}_{1} = {o}_{1} + {k}_{q 1} \frac{{o}_{1} - {u}_{1}}{‖ {o}_{1} - {u}_{1} ‖}$$
$${q}_{2} = {o}_{2} + {k}_{q 2} \frac{{o}_{2} - {u}_{2}}{‖ {o}_{2} - {u}_{2} ‖}$$
where:
l is the light-emitting position,
o₁ and o₁ are a first nodal point and a second nodal point in the 3D coordinate system related to capturing a first image and a second image of the two images, respectively,
k_{q1} is a first distance between a point of reflection on the eye corresponding to the first image, and the first nodal point,
k_{q2} is a second distance between a point of reflection on the eye corresponding to the second image, and the second nodal point,
u₁ and u₂ are a first imaged glint and a second imaged glint of the plurality of imaged glints, respectively, and
R is a radius of the cornea of the eye; and
calculating the cornea center c as:
$$c = \frac{{c}_{1} ( {k}_{q 1} , R ) + {c}_{2} ( {k}_{q 2} , R )}{2} .$$

5. The method of claim 1 further comprising:
repeating said performing the first set of actions, said performing the second set of actions, and said estimating the one or more calibration parameters for a plurality of times thereby obtaining a plurality of versions of the one or more calibration parameters; and
estimating the one or more calibration parameters by combining the plurality of versions of the one or more calibration parameters.

6. The method of claim 1, wherein the third set of actions comprises:
reperforming the first set of actions to re-obtain the plurality of images each having a single imaged glint;
for each of the plurality of images obtained from said reperforming the first set of actions, determining a first gaze direction of the eye in the 3D coordinate system, thereby obtaining a plurality of first gaze directions; and
combining the plurality of first gaze directions to obtain a second gaze direction of the eye in the 3D coordinate system for tracking the eye of the user.

7. A system for performing the method of claim 1, wherein the system comprising:
a light source at the light-emitting position;
a plurality of cameras for image capturing; and
one or more circuits functionally connected to the light source and the plurality of cameras for performing the method of claim 1.

8. The system of claim 7, wherein said determining the cornea center comprises:
for each image of the plurality of images, calculating a center of corneal curvature in the 3D coordinate system, thereby obtaining a plurality of centers of corneal curvature; and
finding an optimal value of the first distance and an optimal value of the radius such that the centers of corneal curvature substantially converge to a converged point, the converged point being the cornea center;
wherein for each image of the plurality of images, the calculation of the center of corneal curvature in the 3D coordinate system is based on:
the light-emitting position,
a nodal point in the 3D coordinate system corresponding to capturing of the image,
a first distance between a point of reflection on the eye corresponding to the image, and the nodal point corresponding to the capturing of the image,
an imaged glint of the plurality of imaged glints corresponding to the image, and
a radius of the cornea of the eye.

9. The system of claim 7, wherein said determining the cornea center comprises:
finding optimal values of k_{qi} and R such that cᵢ (i=1, 2, . . . , N) substantially converge to an optimum point c̅, wherein cᵢ is determined based on:
$$( \frac{l - {q}_{i}}{‖ l - {q}_{i} ‖} - \frac{{o}_{i} - {q}_{i}}{‖ {o}_{i} - {q}_{i} ‖} ) \cdot ( {q}_{i} - {c}_{i} ) = 0$$
for i=1, 2, . . . , N, and
$${q}_{i} = {o}_{i} + {k}_{q i} \frac{{o}_{i} - {u}_{i}}{‖ {o}_{i} - {u}_{i} ‖}$$
where:
l is the light-emitting position,
oᵢ is an i-th nodal point in the 3D coordinate system corresponding to capturing an i-th image of the plurality of images,
k_{qi} is a first distance between a point of reflection on the eye corresponding to the i-th image, and the i-th nodal point,
uᵢ is an i-th imaged glint of the plurality of imaged glints, and
R is a radius of the cornea of the eye.

10. The system of claim 7, wherein the plurality of images are two images; and wherein said determining the cornea center comprises:
computing:
$${min}_{{k}_{q 1} , {k}_{q 2} , R} ‖ {c}_{1} ( {k}_{q 1} , R ) - {c}_{2} ( {k}_{q 2} , R ) ‖$$
where c₁(k_{q1}, R) indicates that c₁ is a function of k_{q1} and R, c₂(k_{q2}, R) indicate that c₂ is a function of k_{q2} and R, and c₁ and c₂ are determined based on:
$$( \frac{l - {q}_{1}}{‖ l - {q}_{1} ‖} - \frac{{o}_{1} - {q}_{1}}{‖ {o}_{1} - {q}_{1} ‖} ) \cdot ( {q}_{1} - {c}_{1} ) = 0$$
$$( \frac{l - {q}_{2}}{‖ l - {q}_{2} ‖} - \frac{{o}_{2} - {q}_{2}}{‖ {o}_{2} - {q}_{2} ‖} ) \cdot ( {q}_{2} - {c}_{2} ) = 0$$
$$and$$
$${q}_{1} = {o}_{1} + {k}_{q 1} \frac{{o}_{1} - {u}_{1}}{‖ {o}_{1} - {u}_{1} ‖}$$
$${q}_{2} = {o}_{2} + {k}_{q 2} \frac{{o}_{2} - {u}_{2}}{‖ {o}_{2} - {u}_{2} ‖}$$
where:
l is the light-emitting position,
o₁ and o₁ are a first nodal point and a second nodal point in the 3D coordinate system related to capturing a first image and a second image of the two images, respectively,
k_{q1} is a first distance between a point of reflection on the eye corresponding to the first image, and the first nodal point,
k_{q2} is a second distance between a point of reflection on the eye corresponding to the second image, and the second nodal point,
u₁ and u₂ are a first imaged glint and a second imaged glint of the plurality of imaged glints, respectively, and
R is a radius of the cornea of the eye; and
calculating the cornea center c as:
$$c = \frac{{c}_{1} ( {k}_{q 1} , R ) + {c}_{2} ( {k}_{q 2} , R )}{2} .$$

11. The system of claim 7, wherein the method further comprises:
repeating said performing the first set of actions, said performing the second set of actions, and said estimating the one or more calibration parameters for a plurality of times thereby obtaining a plurality of versions of the one or more calibration parameters; and
estimating the one or more calibration parameters by combining the plurality of versions of the one or more calibration parameters.

12. The system of claim 7, wherein the third set of actions comprise:
reperforming the first set of actions;
reperforming the second set of actions based on said reperforming the first set of actions; and
estimating a gaze direction of the eye in the 3D coordinate system based on the first direction obtained from said reperforming the second set of actions, and the Kappa angle, for tracking the eye.

13. The system of claim 7, wherein the third set of actions comprises:
reperforming the first set of actions to re-obtain the plurality of images each having a single imaged glint;
for each of the plurality of images obtained from said reperforming the first set of actions, determining a first gaze direction of the eye in the 3D coordinate system, thereby obtaining a plurality of first gaze directions; and
combining the plurality of first gaze directions to obtain a second gaze direction of the eye in the 3D coordinate system for tracking the eye of the user.

14. One or more non-transitory computer-readable storage devices comprising computer-executable instructions, wherein the instructions, when executed, cause one or more circuits to perform the method of claim 1.

15. The one or more non-transitory computer-readable storage devices of claim 14, wherein said determining the cornea center comprises:
for each image of the plurality of images, calculating a center of corneal curvature in the 3D coordinate system, thereby obtaining a plurality of centers of corneal curvature; and
finding an optimal value of the first distance and an optimal value of the radius such that the centers of corneal curvature substantially converge to a converged point, the converged point being the cornea center;
wherein for each image of the plurality of images, the calculation of the center of corneal curvature in the 3D coordinate system is based on:
the light-emitting position,
a nodal point in the 3D coordinate system corresponding to capturing of the image,
a first distance between a point of reflection on the eye corresponding to the image, and the nodal point corresponding to the capturing of the image,
an imaged glint of the plurality of imaged glints corresponding to the image, and
a radius of the cornea of the eye.

16. The one or more non-transitory computer-readable storage devices of claim 14, wherein said determining the cornea center comprises:
finding optimal values of k_{qi} and R such that cᵢ (i=1, 2, . . . , N) substantially converge to an optimum point c̅, wherein cᵢ is determined based on:
$$( \frac{l - {q}_{i}}{‖ l - {q}_{i} ‖} - \frac{{o}_{i} - {q}_{i}}{‖ {o}_{i} - {q}_{i} ‖} ) \cdot ( {q}_{i} - {c}_{i} ) = 0$$
for i=1, 2, . . . , N, and
$${q}_{i} = {o}_{i} + {k}_{q i} \frac{{o}_{i} - {u}_{i}}{‖ {o}_{i} - {u}_{i} ‖}$$
where:
l is the light-emitting position,
oᵢ is an i-th nodal point in the 3D coordinate system corresponding to capturing an i-th image of the plurality of images,
k_{qi} is a first distance between a point of reflection on the eye corresponding to the i-th image, and the i-th nodal point,
uᵢ is an i-th imaged glint of the plurality of imaged glints, and
R is a radius of the cornea of the eye.

17. The one or more non-transitory computer-readable storage devices of claim 14, wherein the plurality of images are two images; and wherein said determining the cornea center comprises:
computing:
$${min}_{{k}_{q 1} , {k}_{q 2} , R} ‖ {c}_{1} ( {k}_{q 1} , R ) - {c}_{2} ( {k}_{q 2} , R ) ‖$$
where c₁(k_{q1}, R) indicates that c₁ is a function of k_{q1} and R, c₂(k_{q2}, R) indicate that c₂ is a function of k_{q2} and R, and c₁ and c₂ are determined based on:
$$( \frac{l - {q}_{1}}{‖ l - {q}_{1} ‖} - \frac{{o}_{1} - {q}_{1}}{‖ {o}_{1} - {q}_{1} ‖} ) \cdot ( {q}_{1} - {c}_{1} ) = 0$$
$$( \frac{l - {q}_{2}}{‖ l - {q}_{2} ‖} - \frac{{o}_{2} - {q}_{2}}{‖ {o}_{2} - {q}_{2} ‖} ) \cdot ( {q}_{2} - {c}_{2} ) = 0$$
$$and$$
$${q}_{1} = {o}_{1} + {k}_{q 1} \frac{{o}_{1} - {u}_{1}}{‖ {o}_{1} - {u}_{1} ‖}$$
$${q}_{2} = {o}_{2} + {k}_{q 2} \frac{{o}_{2} - {u}_{2}}{‖ {o}_{2} - {u}_{2} ‖}$$
where:
l is the light-emitting position,
o₁ and o₁ are a first nodal point and a second nodal point in the 3D coordinate system related to capturing a first image and a second image of the two images, respectively,
k_{q1} is a first distance between a point of reflection on the eye corresponding to the first image, and the first nodal point,
k_{q2} is a second distance between a point of reflection on the eye corresponding to the second image, and the second nodal point,
u₁ and u₂ are a first imaged glint and a second imaged glint of the plurality of imaged glints, respectively, and
R is a radius of the cornea of the eye; and
calculating the cornea center c as:
$$c = \frac{{c}_{1} ( {k}_{q 1} , R ) + {c}_{2} ( {k}_{q 2} , R )}{2} .$$

18. The one or more non-transitory computer-readable storage devices of 14, wherein the method further comprises:
repeating said performing the first set of actions, said performing the second set of actions, and said estimating the one or more calibration parameters for a plurality of times thereby obtaining a plurality of versions of the one or more calibration parameters; and
estimating the one or more calibration parameters by combining the plurality of versions of the one or more calibration parameters.

19. The one or more non-transitory computer-readable storage devices of 14, wherein the third set of actions comprise:
reperforming the first set of actions;
reperforming the second set of actions based on said reperforming the first set of actions; and
estimating a gaze direction of the eye in the 3D coordinate system based on the first direction obtained from said reperforming the second set of actions, and the Kappa angle, for tracking the eye.

20. The one or more non-transitory computer-readable storage devices of 14, wherein the third set of actions comprises:
reperforming the first set of actions to re-obtain the plurality of images each having a single imaged glint;
for each of the plurality of images obtained from said reperforming the first set of actions, determining a first gaze direction of the eye in the 3D coordinate system, thereby obtaining a plurality of first gaze directions; and
combining the plurality of first gaze directions to obtain a second gaze direction of the eye in the 3D coordinate system for tracking the eye of the user.
